(19) United States
(12) Patent Application Publication
(10) Pub. No.: US 2007/0035941 A1
(43) Pub. Date: Feb. 15, 2007

(54) Method for increasing the uniformity of a flat panel light source and the light source thereof

(76) Inventors: Cheng-Chung Lee, Tai-Tung City (TW); Wei-Yi Lin, Yun-Lin Hsien (TW); Yu-Yang Chang, Tai-Nan City (TW); Biing-Nan Lin, Tai-Chung City (TW)

Correspondence Address: LIN & ASSOCIATES INTELLECTUAL PROPERTY, P.O. BOX 2339, SARATOGA, CA, 95070-0339, US

(21) Appl. No.: 11/254,037

(22) Filed: Oct. 19, 2005

(30) Foreign Application Priority Data
Aug. 10, 2005 (TW) 94127161

(51) Int. Cl. G09F 13/04

(52) U.S. Cl. 362/97

(57) ABSTRACT

Disclosed are a method for improving the uniformity of a flat panel light source and the light source thereof. It achieves a diffusion effect by blurring the lighting surface of the light module, thereby makes the outgoing lights more uniform. The blurring process can be performed on the inner or outer surface of a lighting substrate before a flat panel light source is assembled. Otherwise, the blurring process may be performed on an outer surface of an assembled light module. The invention is applicable to a field emission display (FED) back-light or front-light module. The lighting surface of a cathode plate module is blurred for an FED back-light source, and the lighting surface of an anode plate module for an FED front-light source.

### FIELD OF THE INVENTION

The present invention generally relates to field emission display (FED) devices, and more specifically to a method for increasing the uniformity of a flat panel display light source and the light source thereof.

### BACKGROUND OF THE INVENTION

Liquid crystal display (LCD) devices are quite popular in the electronics market. They are widely used in large-size monitors for desktop computers and small-size display screens for portable electronics devices. FIG. 1 shows a schematic view of a conventional LCD back-light module. The LCD module uses a cold cathode fluorescent lamp (CCFL) 100 as its back-light source. As can be seen from FIG. 1, the back-light module uses diffusion films 103a-103b and prisms lens 105 in addition to a light guided plate 101 to uniformly diffuse the back-light towards a display screen (not shown here).

In recent years, FED display devices have become one of the major display devices widely studied by many research and development groups. FIG. 2 shows a schematic view of a conventional FED display device with a front-light module. This kind of FED display devices mainly contains a cathode plate module and an anode plate module. The cathode plate module consists of a first substrate 201, a cathode line 203 formed on the surface of first substrate 201, a gate line 205, plural emitters 207, and a dielectric layer 209. The anode plate module consists of a second substrate 211, an Indium-Tin-Oxide (ITO) layer 213 formed on the inner surface of second substrate 211, a layer of phosphor powder 215 formed on the ITO layer 213.

Emitters 207, such as carbon nanotube (CNT) and conductor or metal (e.g., Si, Mo, and ZnO) tip, can emit electron beams under low operation voltages. The emitted electrons bombard the phosphorus powder 215 and cause it to emit lights. The emitted lights pass through the transparent ITO layer 213 and the second substrate 211 of the anode plate module. A flat panel light source using a front-light module can be created this way.

A flat panel light source with the aforementioned FED front-light module may save the material cost of light guided plate, diffusion films, and prism lens. However, the efficiency and uniformity of the light source still need to be improved.

### SUMMARY OF THE INVENTION

The present invention proposes a method for improving the uniformity of a flat panel light source to overcome the drawback of poor light uniformity provided by conventional FED flat panel light sources. In this method, lights emitted from an FED flat panel light source are diffused through a lighting surface of the light module with no requirement of diffusion films. Therefore, the lights emitted from a flat panel light source can be uniformly projected towards a display screen.

In the first and the second embodiments of the present invention, the flat panel light sources are made of FED back-light modules. In the third embodiment of the present invention, the flat panel light source is made of an FED front-light module.

In the first embodiment, there are two major steps required for improving the uniformity of a flat panel light source. Firstly, the upper surface of a first substrate is blurred. Secondly, plural patterned cathode lines, gate lines, and emitters are formed on the blurred upper surface. Combining this cathode plate module with an existing anode plate module can form a flat panel light source.

The difference between the second embodiment and the first embodiment is the surface to be patterned. In the second embodiment, plural patterned cathode lines, gate lines, and emitters are formed on the plain surface of a first substrate instead of the blurred surface. This cathode plate module is then combined with an existing anode plate module to form a flat panel light source.

In the first and the second embodiments, a blurring process is performed on the upper surface of a first substrate before a flat panel back-light source is assembled.

In the third embodiment, there are two major steps required for improving the uniformity of a flat panel light source. Firstly, the upper surface of a second substrate of an anode plate module is blurred. Secondly, a patterned ITO layer and then a phosphorus powder layer are formed on the lower surface of the second substrate. This anode plate module is then combined with an existing cathode plate module to form a flat panel light source. In the third embodiment, a blurring process is performed on the surface of a second substrate before a flat panel front-light source is assembled.

In the aforementioned three embodiments, a blurring process is performed on the surface of a substrate before a flat panel light source is assembled.

In the fourth and the fifth embodiments, a blurring process is performed on the outer surface of an assembled plate after a flat panel light source is assembled. In the fourth embodiment, the blurring process is performed on the outer surface of a conventional flat panel front-light source. In the fifth embodiment, another blurring process is performed on the outer surface of a flat panel light source assembled by the method of the first embodiment. This additional blurring process creates a foggy outlook on an outer surface of the flat panel light source.

According to the aforementioned two embodiments, the light-emitting surface of a flat panel light source is blurred to achieve a light diffusion effect. And then, the light diffusion results in an improvement of the uniformity of the flat panel light source.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of a conventional LCD back-light module.

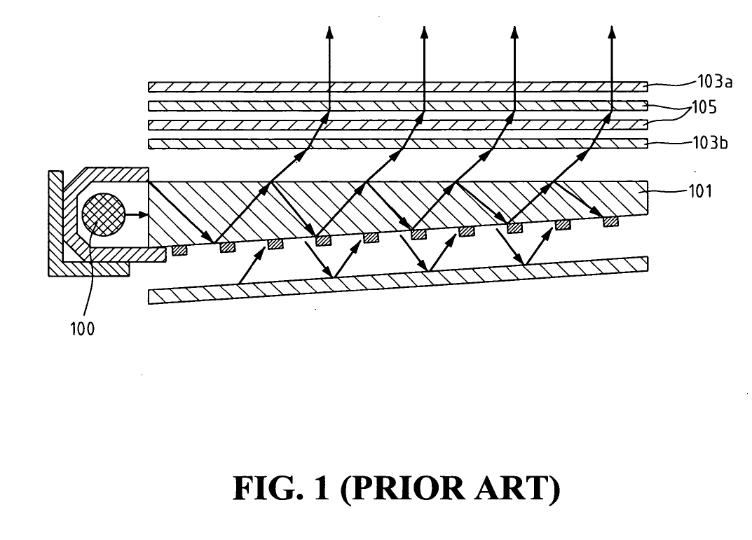

FIG. 2 shows a schematic view of a conventional FED display device with a front-light module.

FIG. 3 shows a schematic view of a conventional FED display device with a back-light module.

FIGS. 4A-4D depict a processing flow used in the first embodiment of the present invention.

FIG. 5 shows a schematic view of a flat panel light source of the second embodiment of the present invention.

FIGS. 6A-6D depict a processing flow used in the third embodiment of the present invention.

FIG. 7A-7B depict a processing flow used in the fourth embodiment of the present invention.

FIG. 8 shows a schematic view of a flat panel light source of the fifth embodiment of the present invention.

### DETAILED DESCRIPTION OF THE PREFERRED EMBODIMENTS

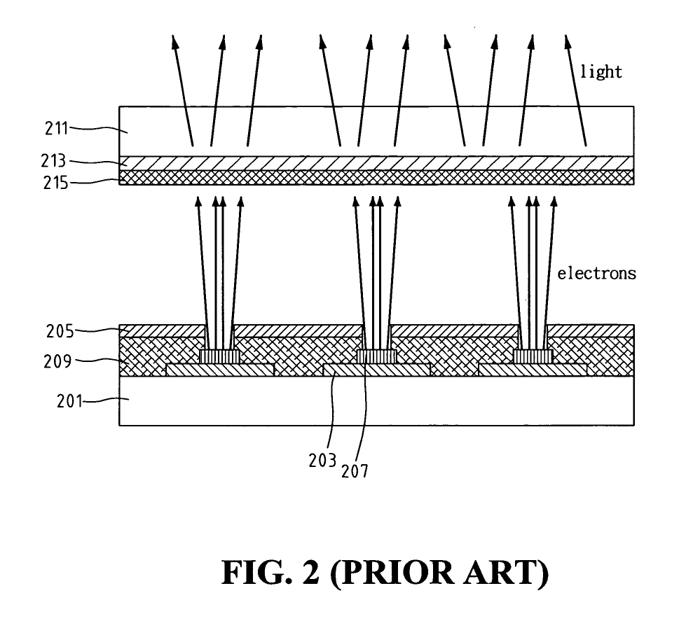

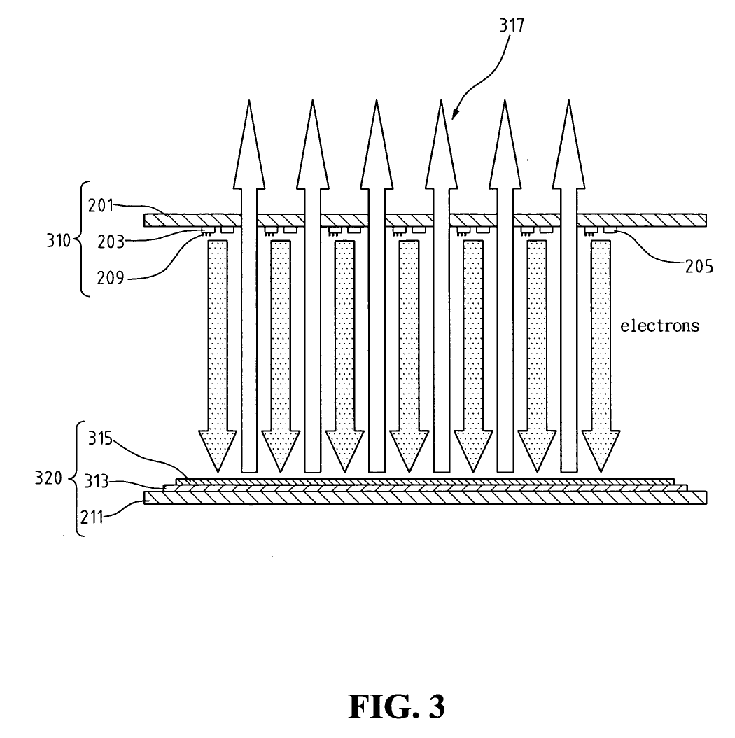

The structure of an FED back-light module is different from that shown in FIG. 2 which depicts a schematic view of a conventional front-light module. The electron beams generated in an FED back-light module bombard the phosphorus powder on an anode plate module and cause it to emit light. The emitted lights are reflected and then pass through a transparent substrate. A flat panel light source using a back-light cathode plate can be created this way. As can be seen from FIG. 3, the electron beams emitted from a cathode plate module 310 bombard the phosphorus powder 315 on an anode plate module 320 and cause it to emit lights 317. The emitted lights 317 are reflected at the reflected layer 313 located under the phosphorus powder 315, and then pass through a transparent substrate 201 in the cathode plate module 310.

As mentioned earlier, an FED flat panel light source comprises either an FED front-light module or an FED back-light module. The following embodiments will depict in detail how these two kinds of FED light modules improve the uniformity of flat panel light sources.

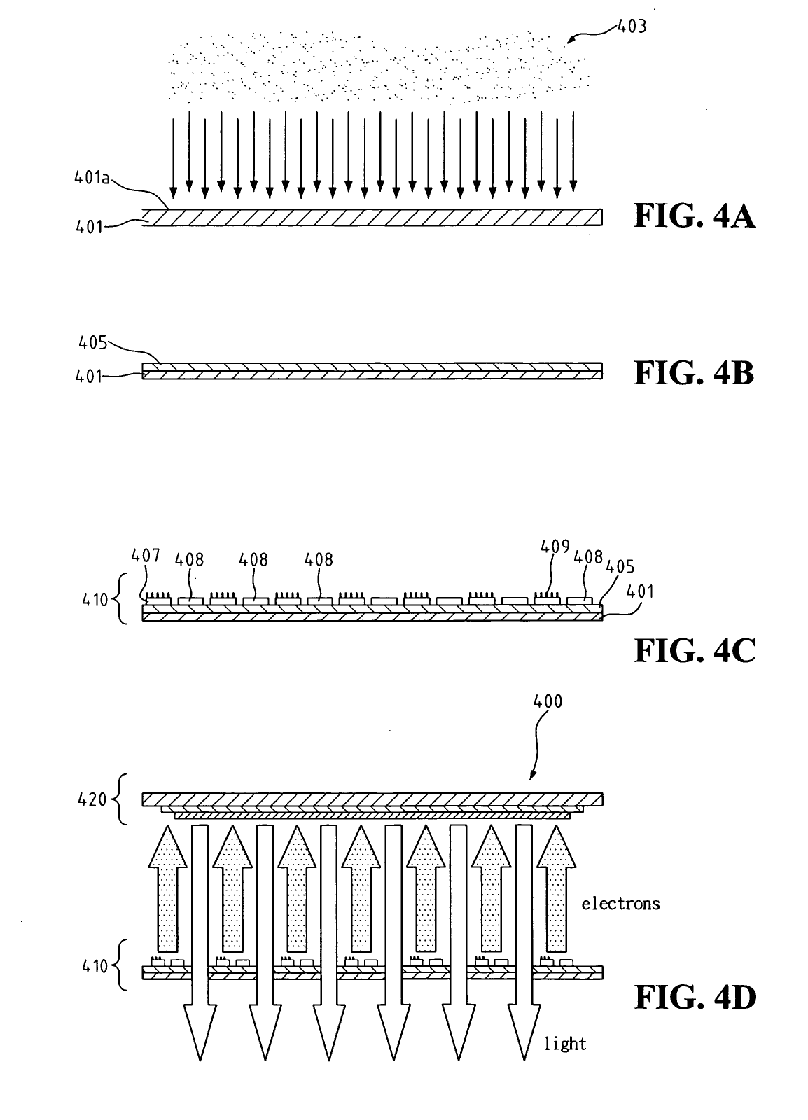

FIGS. 4A-4D depict a processing flow used in the first embodiment of the present invention. Firstly, a first substrate 401 is prepared and its upper surface 401a is blurred as shown in FIG. 4A. The blurring methods include sand blasting, etching, and laser heating. Said blurring process can eliminate the need of diffusion films and reduce manufacturing cost. The blurring process shown in FIG. 4A is sand blasting 403. A blurred upper surface 405 is created and shown in FIG. 4B. Secondly, plural patterned cathode lines 407 and gate lines 408 are formed on the blurred upper surface 405. There are plural emitters 409 deposited on each cathode line 407. Combining this cathode plate module 410 with an existing anode plate module 420 can form an FED flat panel back-light source 400, as shown in FIG. 4D.

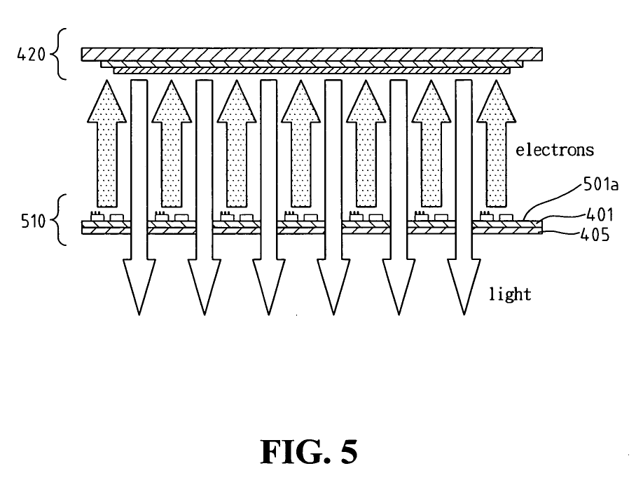

FIG. 5 shows a schematic view of a flat panel light source of the second embodiment of the present invention. Comparing FIG. 5 of the second embodiment with FIG. 4D of the first embodiment, the difference is the surface to be patterned. In the second embodiment, plural cathode lines 407, gate lines 408, and emitters 409 are formed on the other surface 501a of the first substrate 401 instead of the blurred surface 405. A cathode plate module 510 is then formed and further combined with an existing anode plate module 420 to form a flat panel light source.

In the first and the second embodiments, a blurring process is performed on a surface of the first substrate 401 before a flat panel back-light source is assembled. This same processing step is not repeatedly depicted in FIG. 5.

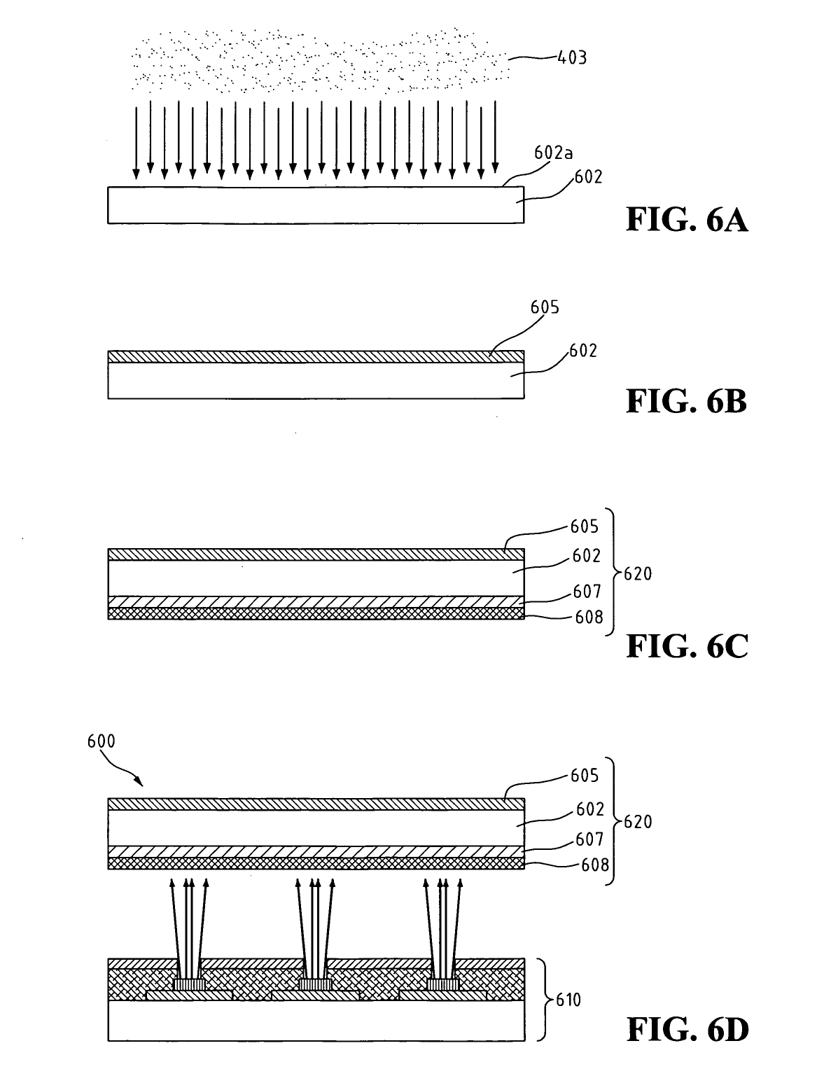

FIGS. 6A-6D depict a processing flow used in the third embodiment of the present invention. Firstly, a first substrate 602 is prepared and its upper surface 602a is blurred as shown in FIG. 6A. As described earlier, the blurring methods include sand blasting, etching, and laser heating. The blurring process shown in FIG. 6A is sand blasting 403. A blurred upper surface 605 is created and shown in FIG. 6B. Secondly, an ITO layer 607 is formed on the lower surface of the second substrate 602 and a phosphorus powder layer 608 is formed on the surface of the ITO layer 607, as shown in FIG. 6C. These two steps create an anode plate module 620. This anode plate module 620 is then combined with an existing cathode plate module 610 to form an FED flat panel front-light source 600, as shown in FIG. 6D.

In the aforementioned three embodiments, a blurring process is performed on the surface of a substrate before a flat panel light source is assembled with an anode plate module and a cathode plate module.

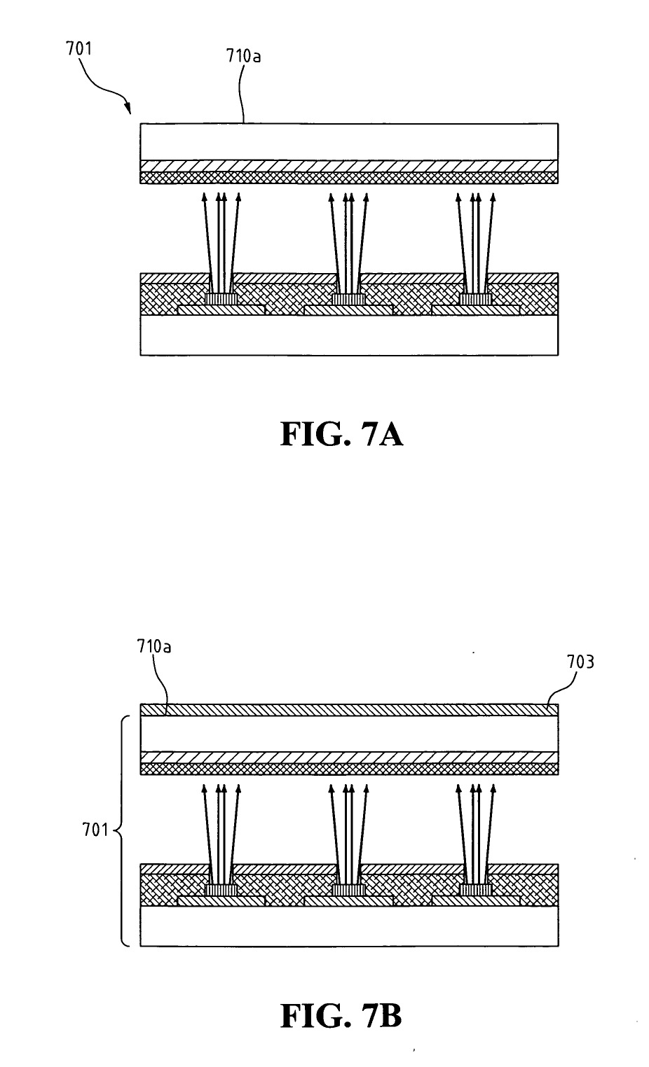

According to the present invention, a blurring process can be performed on the outer surface of an assembled plate after a flat panel light source is assembled. In the fourth embodiment, a conventional flat panel front-light substrate 701 is prepared, as shown in FIG. 7A. The blurring process is performed on the lighting surface 710a (i.e., the outer surface of an anode plate module) of the flat panel front-light plate 701 to form a foggy layer 703. A flat panel light source 700 with good uniformity is then created, as shown in FIG. 7B.

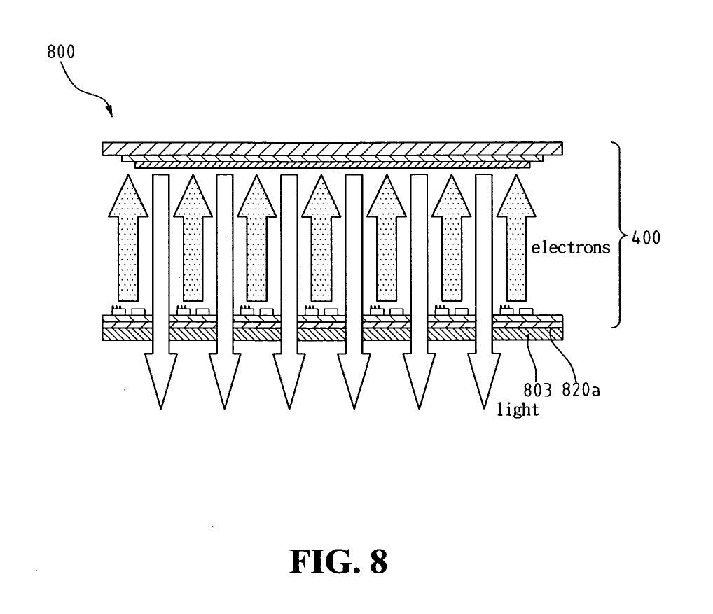

In the fifth embodiment, another blurring process is performed on a lighting surface 820a (i.e., an outer surface of a cathode plate module) of a flat panel light source 400 assembled by the method of the first embodiment. This additional blurring process creates a foggy layer 803 on an outer surface of the flat panel light source. A flat panel light source 800 with good uniformity is then created, as shown in FIG. 8.

In summary, the present invention adopts a blurring process to blur a lighting surface of an FED flat panel light module and achieve a diffusion effect. Therefore, lights emitted from the FED flat panel light module are diffused through the lighting surface and uniformly projected towards a display screen. The blurring process can be performed on the inner or outer surface of a lighting substrate before a flat panel light source is assembled. Otherwise, said blurring process may be performed on an outer surface of an assembled light module. This invention can be applied to an FED flat panel light source with either a back-light or front-light module. The blurring methods include sand blasting, etching, and laser heating. Said blurring process can eliminate the need of diffusion films and reduce manufacturing cost.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for improving the uniformity of a flat panel light source, said flat panel light source comprises a cathode plate module and an existing anode plate module, wherein said cathode plate module is a light emitting module, said method comprises the following steps:
prepare a substrate having an upper surface and a lower surface, and blur said upper surface of said substrate;
form plural patterned cathode lines and gate lines on a surface of said substrate to create said cathode plate module, wherein plural emitters are formed on each said cathode line; and
assemble said cathode plate module and said existing anode plate module to form said flat panel light source.

2. The method for improving the uniformity of a flat panel light source as claimed in claim 1, wherein said flat panel light source is a field emission display (FED) flat panel light source.

3. The method for improving the uniformity of a flat panel light source as claimed in claim 1, wherein the process for blurring said upper surface of said substrate is chosen from the group of sand blasting, etching, and laser heating.

4. The method for improving the uniformity of a flat panel light source as claimed in claim 1, wherein said surface having said plural patterned cathode lines and said gate lines thereon is the lower surface of said substrate.

5. The method for improving the uniformity of a flat panel light source as claimed in claim 1, wherein said surface having said plural patterned cathode lines and said gate lines thereon is said blurred upper surface of said substrate.

6. A method for improving the uniformity of a flat panel light source, said flat panel light source comprises an anode plate module and an existing cathode plate module, wherein said anode plate module is a light emitting module, said method comprises the following steps:
prepare a substrate having an upper surface and a lower surface, and blur said upper surface of said substrate;
form an Indium-Tin-Oxide (ITO) layer under said lower surface of said substrate and a phosphorus powder layer under said ITO layer to create said anode plate module; and
assemble said anode plate module and said existing cathode plate module to form said flat panel light source.

7. The method for improving the uniformity of a flat panel light source as claimed in claim 6, wherein said flat panel light source is an FED flat panel light source.

8. The method for improving the uniformity of a flat panel light source as claimed in claim 6, wherein said blurring process is chosen from the group of sand blasting, etching, and laser heating.

9. A method for improving the uniformity of a flat panel light source, wherein said flat panel light source is formed by combining an anode plate module and a cathode plate module, said flat panel light source has a lighting surface, said method comprises the steps of directly blurring said lighting surface.

10. A flat panel light source having an FED flat panel light module, said flat panel light source comprises a cathode plate module and an anode plate module, one out of said two modules is a light emitting module, said light emitting module comprises at least a substrate, and an outer surface of said substrate is a blurred lighting surface.

11. The flat panel light source as claimed in claim 10, wherein said light emitting module is said cathode plate module.

12. The flat panel light source as claimed in claim 10, wherein said light emitting module is said anode plate module.

13. The flat panel light source as claimed in claim 11, wherein said cathode plate module comprises:
a substrate having said blurred lighting surface;
plural patterned cathode lines and gate lines formed on said blurred lighting surface; and
plural emitters formed on each said cathode line.

14. The flat panel light source as claimed in claim 11, wherein said cathode plate module comprises:
a substrate having said blurred lighting surface and another surface;
plural patterned cathode lines and gate lines formed on said another surface; and
plural emitters formed on each said cathode line.

15. The flat panel light source as claimed in claim 12, wherein said anode plate module comprises:
a substrate having an upper surface and a lower surface, said upper surface is said blurred lighting surface;
an ITO layer under said lower surface of said substrate; and
a patterned anode layer and a phosphorus powder layer formed under said ITO layer.

16. The flat panel light source as claimed in claim 11, wherein said anode plate module comprises a reflected material to reflect said field emitted lights towards said cathode plate module.
